(19) United States
(12) Patent Application Publication
(10) Pub. No.: US 2005/0180343 A1
(43) Pub. Date: Aug. 18, 2005

(54) Method and device for wireless network formation

(76) Inventor: Sander Van Valkenburg, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/507,793

(22) PCT Filed: Mar. 12, 2002
(86) PCT No.: PCT/IB02/00709

(51) Int. Cl. H04B 7/00

(52) U.S. Cl. 370/310

(57) ABSTRACT

The invention relates to a method and network device for forming a wireless network, by a first network device 6 and a second network device 4 in a wireless personal area network (PAN) environment, by the steps of connecting said first network device 6 with said second network device 4; determining at least one service provided by said second network device 4, said determining step being carried out by said first network device 6; and implementing said determined service in said first network device 6.

This invention relates to a method for network formation, based on relaying an available service to another device. The invention focuses on Bluetooth networking, and in particular on networking using the Personal Area Networking (PAN) profile. The presented invention extends a provided service to a larger area than one single Bluetooth piconet, and aids in the forming of multihop networks accessing a certain service.

Conventional networks, for example a network of microprocessor controlled devices such as computers, printers, modems etc. have relied upon physical wire connections between the devices in the network. Due to the physical nature of the connection required, conventional networks are generally perceived to be fairly rigid in nature. For example, in order to add an additional device into the network, the additional device must be physically connected to the network, and the network server may have to be informed that the additional device has been connected.

Recently however, it has been observed an emerge of wireless networks, in which the network connections are provided, typically, by a wireless radio link. One of these networks is described in the various Bluetooth standards (see e.g. http://www.Bluetooth.com). Those skilled in the art will appreciate that other wireless networks also exist, and reference herein to Bluetooth is not intended to be limited hereto.

Bluetooth wireless technology allows users to make effortless, wireless and instant connections between various communication devices, such as mobile phones, computers, printers etc. Bluetooth technology provides for a short-range wireless connectivity and supports both point-to-point and point-to-multipoint connections. Currently, up to seven active ‘slave’ devices can communicate with a ‘master’ device, to form a ‘piconet’. Several of these ‘piconets’ can be established and linked together in ad hoc ‘scatternets’, to allow communication among continually flexible configurations.

Prior solutions concerning connections between piconets, such as WO 99/14898 regarding ‘Contemporaneous connectivity to multiple piconets’ have been based on the utilization of specified Bluetooth low-power modes and negotiated time periods and were therefore bound to act within certain corresponding limits, e.g. communication overhead resulting from parameter varying traffic loads and topologies to a minimum.

Simple network formation techniques such as listening and responding to every inquiry (resulting in a connection), or continuously trying to search for new devices to connect to, may lead to non-optimized network topologies. It also does not give connecting devices adequate access to a service that is reachable over multiple hops.

One of the problems with the creation of wireless networks is the limitation to a maximum of seven slaves in a piconet of a Bluetooth network.

Another problem with the creation of wireless networks is the fact that the network devices are movable and have a limited range and that links changes with the location of each network device.

Another problem with the creation of slotted networks is that there is no solution for automatic network formation for scatternets.

Another problem with the creation of slotted networks is to form wireless networks with optimized network topologies.

According to a first aspect of the present invention, there is provided a method of network formation, by a first network device and a second network device in a wireless personal area network environment, by the steps of: connecting said first network device with said second network device, determining at least one service provided by said second network device, and implementing said determined service in said first network device.

The first network device detects services provided by network devices within its range, and in the following pretends and arranges to offer these services itself. The service can be e.g. an execution service like a printing service, an access service like e.g. an internet gateway, or simplest a single device or network name, if no dedicated service is provided. If e.g. a third device tries to connect a service, the device can directly connect the second device as a provider of the service in a conventional way. The third device can connect the first device pretending to offer the same service, and relaying the service between the first device and the second device, if e.g. the third device fails to connect the second device directly. piconet, whereas said second network preferably acts as a master in said first piconet.

According to another aspect of the present invention a method for forming a wireless network, by a first network device with a predetermined service in a wireless personal area network (PAN) is provided. The method comprises the steps of: connecting said first network device with at least one second network device present in said wireless PAN environment, checking if said second network device provides a predetermined service, and implementing said service in first network device, if said second device is found to provide said predetermined service.

The principle of the second method differs from the aforementioned first method by searching for a determined or desired service. The desired service has to be entered or selected by direct or indirect user input in the first network device. If the first device can not find the predetermined service the connection to the second device can be interrupted or maintained until another device is detected or connected. This network formation method provides the option to connect only a single (or more than one) service. The service can be e.g. a pre-determined access of a device or a network e.g. with a predetermined name. The first network device is actively searching for a certain service, and if a device can not provide the determined service, the connection is terminated and the device keeps on searching until the predetermined service is found. The second device can be a single device or represent multiple second devices within a range. The predetermined service can be e.g. such service as a printing service, or a temporal service as e.g. providing a local network during e.g. a meeting.

Both above described network formation methods can be used to extend the range of a single wireless network device by other network devices in the range of the second network device indicating that a service is directly or indirectly accessible.

Preferably, said connecting step comprises the steps of: searching said PAN environment for network devices by applying an inquiry procedure, selecting network devices recited in an information obtained during said inquiry procedure and connecting said first network device to said selected network devices. The selected and connected network devices are designated as second network devices. A pre-selection of devices to be connected that may provide a desired service can reduce the overall time required to find a predefined service. The pre-selection during the inquiry procedure is used to prevent time consuming connections to devices incapable of providing said predefined service. The device can pre-discard connections to devices that can not provide the desired service and can therefore reduce transmission time and speed up the search for the desired service.

Advantageously, the method further comprises the step of connecting said first network device to at least one third network device. By establishing a connection to third devices a single connection of two devices is extended to a multi hop network. The connection to third devices can be established by actively searching for third devices by the second device or by accepting a connection request from a third device.

In this latter aspect of the invention the first network device preferably acts as a master in a second piconet, whereas the third network device preferably acts as a slave in said second piconet.

The connecting third device may execute the same method the first device used to establish the connection to the second device. Therefore the service provided by the first device, maybe including the services of the second device, is implemented in the third device. By repeatedly executing the method of connecting two single devices, a whole network can be formed providing the same service throughout the whole network. If the service is provided by a master only device, the master on top of the network can be detected easily.

Conveniently, the method further comprises the steps of relaying said service from said second network device to said third network device, and vice versa, via said first network device. The first device pretends to provide said service of the second device, but may not be capable to provide the service itself, so the first device relays the service from the second device to the third device thereby preferably acting as a slave in said first piconet and as a master in said second piconet at the same time. From the third devices point of view, it seems that the first device provides the service directly. This includes the advantage that a third device can access a service that is provided by a device out of the range of the wireless connection of the third device, via a relay. The service is preferably relayed mono-directionally from master to slave.

Advantageously the method, further comprises a step of forwarding data according to said relayed service between said second network device and said third network device, via said first network device. By relaying the data transfer from the second to the third device, via said first network device and viceversa, the full operability of the service can be relayed from a single network device to other devices. The operability of the service relay is not restricted by the number of service relays or the number of forwards between the originator of a service and the target device, the service is relayed to. The first device pretends to provide said service related data to said third device, but just forwards the service related data from the second device to the third device and vice versa. The first device acts thereby as a slave in said first piconet and as a that the first device provides the service related data directly. The service related data are relayed bi-directionally between the master and slave.

Preferably said wireless PAN environment is a Bluetooth environment. In Bluetooth environments the present invention can extend the service of a master device to more than only seven slave devices. By relaying the service of a single device via more than one relay device the number of devices in a network is not limited, and the service or the name of the network is defined even in large scatternets.

Advantageously, said first network device is connected to said second network device via a first piconet. Conveniently, said first network device is connected to said third network device via a second piconet. The piconets are defined in the Bluetooth standard. The first network device can connect the second and/or the third network device via piconet connection. If one of the both connection is not a Bluetooth connection, the first network device acts as a gateway between the Bluetooth and the other connection, relaying services between both devices. If the second and the third device are both connected via a Bluetooth connection, the first device can be master to both devices, master to one of the devices and slave to both devices. In the first case, the connections can built up a conventional piconet with the a master and two slaves. In the third case, being slave to both devices, the first device can not relay any service, but would only offer to relay the services of both master devices to e.g. other devices. In the second case the device relays a service from the second device to the third device, because the first device only implements the services of the second device. To ensure that a Bluetooth (BT) device can connect another BT device, the connection seeking BT devices connects other devices as a slave device. This is because a single BT device can accept up to seven slave devices but only one master device in a single piconet, so it is more important to connect a device in a BT environment as a slave than as a master.

To operate simultaneously as a master in one piconet and as a slave in another piconet the first device must be able of inter piconet communication. This inter piconet communication may be executed with only one transceiver unit, if the first device synchronizes the transmission slots of its master device with the transmission slots of its own piconet. The first device must further be able to follow two different hopping sequences. By skipping one of its slave devices, the first device can fully communicate with its master device. For a fully independent operation in two different piconets, the first device is to comprise two sets of transceiver elements.

Conveniently, the determination or checking of provided services is executed by querying a Service Discovery Protocol (SDP) database of said second network device. The SDP database is to be provided in the second BT device according to the Bluetooth specification Version 1.1. The SDP database contains the services provided by the respective device, and further contains e.g. user readable descriptions of the provided service. A device connecting a BT device can detect provided services by querying the SDP database records.

Preferably, the implementation of said service in said first network device is executed by storing said service in a SDP database of said first network device. If a third device queries the SDP database of the first device it can read out the service entry of the service actually provided by the second device. To provide the service to the third device, the first device relays the service and the communication between the second device to the third device.

Advantageously, said first network device advertises said relayed service to other devices to establish said first network device as a master of a second piconet.

Conveniently, said first network device is forming said second piconet by connecting third network devices in said PAN environment. The connections of the second piconet can be established either by actively searching for devices to be connected or by responding to connection requests from third devices.

Preferably, the method further comprises the step of transferring connection related data from said first piconet to said second piconet, and vice versa. As the connections between the single devices of the wireless network are more or less arbitrary, the network topology may be sub optimal. By transferring connection related data between the single network elements, one device may execute a program to optimize the topology of the network formed by the above mentioned methods. The connection related data may also be used to optimize the relaying of the services. The access time of a service accessed via e.g. four relaying network devices with am maximum of up to seven slaves may be divided by the factor of 7×7×7=343 compared to the access time of a service provided by a direct master. To prevent such drastic reductions of the access time the number of slaves of each service relay may be limited to a number below seven.

According to another aspect of the present invention, a software tool is provided. The software tool comprises program code means for performing the steps of the aforementioned method of network formation when said program is run on a network device. This software tool may be combined with other software tool to provide a program to optimize wireless networks or even network cluster with different network elements.

According to another aspect of the present invention, a computer program is provided comprising program code means for performing the steps of the aforementioned methods of network formation when said program is run on a network device. The program is to be executed on each network device, that tries to connect another network device.

According to yet another aspect of the invention, a computer program product is provided comprising program code means stored on a computer readable medium for carrying out the method for network formation of the preceding description when said program product is run on a network device.

According to an other aspect of the present invention a network device capable of executing the aforementioned network formation method is provided. The device is capable of inter piconet communication, and comprises at least one transmitting and at least one receiving means may be in the form of a transceiving means, means for operating said transmitting and receiving means to connect the device with at least a first piconet and a second piconet at the same time, i.e. simultaneously or at different times. The transmitting means and the receiving means can be a single transceiver or designated transmitter and receiver units. The means to operate the transceiver has to be able to follow the frequency hopping pattern of both piconets. In the simplest case such a device can be embodied as a computer or a network device with two different BT modules that can be operated independently. In this case it has to be prevented that one of said modules connects the other vial a piconet connection, and that both modules operate their piconets synchronously. An inter piconet communication enabled device may only comprise a single transceiver, if the device is operated in one piconet as a slave and in the other piconet as a master or slave. If the piconet in which the device is a slave comprises the maximum number of 7 slaves the communication with its master device requires only approximately the seventh part of the air time of the transceiver, therefore the transceiver can operate 6/7 of its duty cycle or operation time as a master device in its own piconet. If its master is connected to less than 7 slaves, more time is available for communication with the master, and the communication to the slave devices may be restricted or may even get impossible. It is to be noted that in this operation mode the transmission and reception slots of both piconets have to be synchronized to prevent the waste of slots during reception and transmission while the frequency hopping sequence of the piconets have to be unsynchronized.

Preferably, the network device further comprises means to relay data traffic from said first piconet to said second piconet. Such a means can be e.g. a data queue accessible from two piconets, and additional address memories to store e.g. address and relay routes.

Conveniently, the network device further comprises means to determine a service provided by a connected second network device, and means to implement said service. This feature can be implemented e.g. by a software for querying a connected device for provided services. In the case of Bluetooth this can be embodied by a program to check the SDP database of a connected device. The means to implement found services can be a SDP database in Bluetooth devices. Therefore, it is advantageous for a Bluetooth device to further comprise a SDP database. If the device offers a gateway functionality, means has to be provided to relay the service from one network to another.

According to another aspect of the invention a network is provided that comprises the above described network devices. Such a network is preferably formed by the above described methods and relays services via relay devices from one device to another.

In the following, the invention will be described in detail by referring to the enclosed drawings in which:

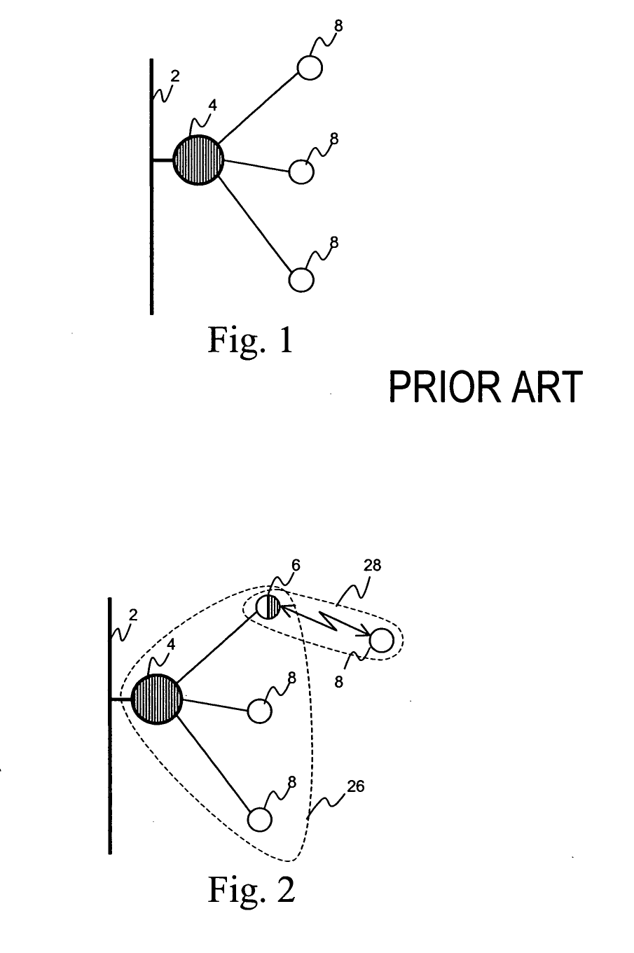

FIG. 1 shows a network topology with a single conventional piconet,

FIG. 2 shows the formation of a service relay in a network according to the present invention,

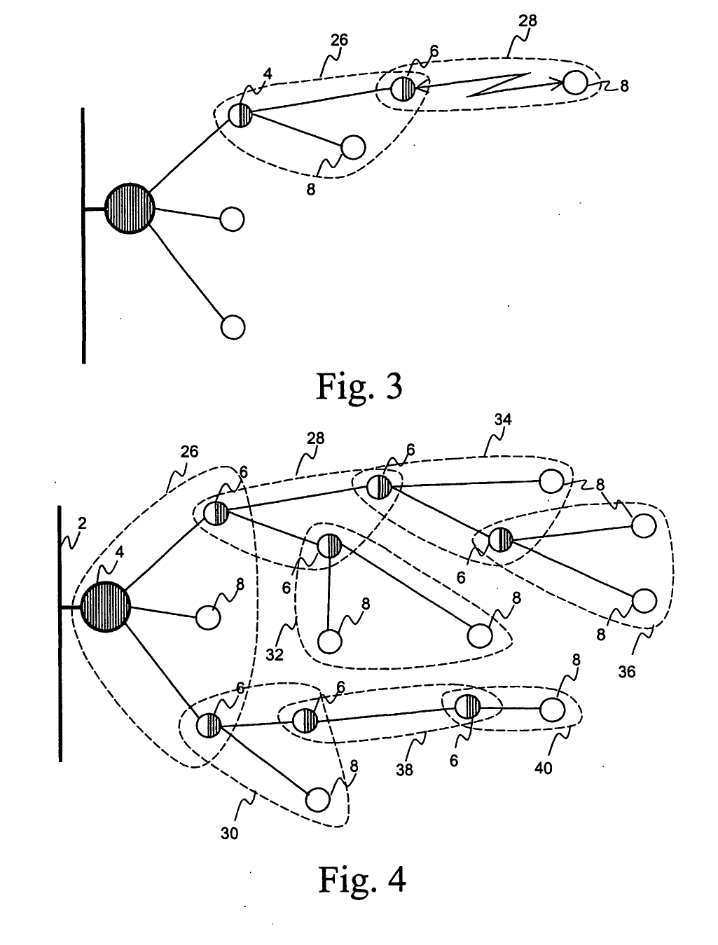

FIG. 3 shows the forming of a network by repeating the process described in FIG. 2,

FIG. 4 shows a tree network topology formed by the method according to the invention,

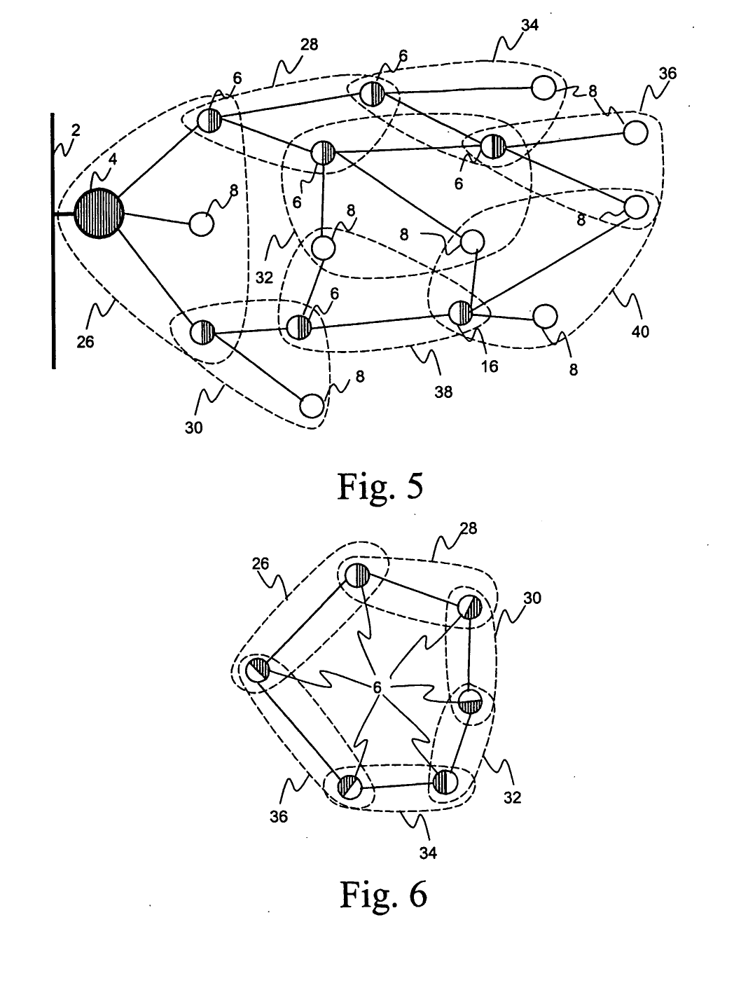

FIG. 5 shows a meshed network topology formed by the method according to the invention,

FIG. 6 shows a ring topology formed by the method according to the invention,

FIG. 1 depicts a conventional piconet in a Bluetooth PAN (Personal Area Network) environment, with one master device 4 and three slave devices 8. The PAN can be a single piconet or a scatternet. The master device provides a service, e.g. a “local network and internet access service”. The local network is indicated as the line 2. Currently, connections between devices 4, 8 equipped with Bluetooth wireless technology have to be set up manually. For single piconet ad-hoc networking, the networking service (i.e. the provision of an IP sub-network through forwarding of packets between Bluetooth connections) that is provided by the piconet master 4, as defined in the PAN profile, phase I, can be discovered using the Bluetooth Service Discovery Protocol (SDP). The specification of the Bluetooth technology can be seen e.g. in the Internet at www.Bluetooth.org. The content of the SDP database can then be displayed so that the user can access this service. In most networking scenarios, a device providing a networking service (e.g. a Network Access Point (NAP) or Group ad-hoc Node (GN) in the PAN profile) will allow more than one user to connect to its service, and will therefore be the master of its Bluetooth piconet. Forming conventional piconets, other Bluetooth devices can connect to the master 4 or the slaves 8, but information about connected devices or accessible services are not transferred automatically and therefore a device in a scatternet can not detect more than the services provided by the devices it is directly connected to.

FIG. 2 shows a node in a network according to the present invention, wherein the device 6 which is slave of a master device 4, is connecting to a new device 8. The master device 4 is depicted as the network access point (NAP) 4. The NAP 4 forms a first piconet 26 with the slave devices 8, 6. The piconet 26 is indicated by a dotted line. According to the invention the device 6 which is capable of inter piconet communication, is connected to the NAP 4 as a slave, and reads out the service record (e.g. the SDP database) of the NAP 4. The read out service record is implemented (e.g. by copying to its own SDP database) and is advertised to form a second piconet 28. The Bluetooth device 6 is the master of the second piconet 28 the device 8 tries to connect to. The device 8 of the piconet 28 connects the device 6, and discovers the service record indicating that device 6 provides the service of its master NAP 4. Instead of directly connecting to the NAP 4 the device 8 in Piconet 28 can connect the device 6, and access the service of the NAP 4 via the network device 6 acting a s a service relay.

In the description the device 6 connects the NAP 4 without searching for a certain service to be provided. The device 6 may also be searching for a certain predefined service provided e.g. by NAP 4. The Bluetooth device 6, capable of inter-piconet communication, can search for a pre-selected service (e.g. a network access) by discovering devices through an inquiry procedure, connecting to a subset of them wherein the selection is based on information received within the inquiry response. Subsequently the SDP service database of each selected and connected device is queried until the desired service is found. Then the device connects to the provider the desired service (NAP 4), and joins its piconet 26. The following text applies to the device that joined the PAN and supports the present invention. This device will be called Service Relay 6.

The Service Relay 6 connects to NAP 4 as a piconet slave. The master of this piconet is either the host (originator) of the PAN, or also a Service Relay. The Service Relay 8 subsequently forms its own piconet (28). It accepts new incoming connection requests, or actively tries to establish new connections by searching for other devices 8. The service that the Service Relay 6 advertises for this PAN is the same as the service it is connected to as piconet slave i.e. it has the same name and contains the same attributes. Therefore the slaves 8 of the piconet 28 of which the Service Relay 6 is the master will perceive that they are connected to the advertised service directly. Thus the Service Relay 6 provides relaying of BNEP traffic (and/or IP traffic) as well as relaying the service including the service attributes towards its piconet slaves 8. The number of slaves in the piconet of the Service Relay 6 may be limited, in order to provide as much bandwidth to each slave 8 as possible.

FIG. 3 shows the forming of a network by repeating the process described in FIG. 2. With the similar structure as in FIG. 2 the service relay 4 of the piconet 26 provides a service. The service is relayed from the NAP in FIG. 2. The Service Relay 4 is the master of the piconet 26, and the master of the piconet device 8 and the inter piconet communication enabled device 6. As in FIG. 2 the device 6 reads out the services provided by the Service Relay 4, and implements found service in its own SDP database. The device 6 advertises the service relayed from the service relay 4, and in turns relays the service to the device 8 of piconet 28. By repeating these steps the Network grows in a tree like fashion. To simplify the structure of the following figures originators of a service are related to the reference number 4, Service Relays are related to the reference number 6 and slave only devices are related to the reference numeral 8.

Security and configuration information is also naturally relayed by the Service Relay (provided the forwarding service has a bridging nature). Therefore provision of configuration and security mechanisms are equal across the whole network. IP configuration and security servers are reachable through the service relays between a device and the originator. E.g. a DHCP server advertisement propagates through the network by forwarding of the advertisement by the Service Relay. Responses to these advertisements are again forwarded by the Service Relay from the responding device to the DHCP server. Security associations at layers above the Bluetooth-specific protocol layers (Baseband, LMP and L2CAP) between two devices propagate in the same manner.

Bluetooth security requirements are relayed as well. The Service Relay operates in the same Bluetooth security mode as the originator with respect to the relayed service. If in order to access the service (i.e. join the network) a device has to e.g. authenticate itself and encrypt all Bluetooth Baseband packets, then each device connecting to the Service Relay and accessing the relayed service also has to authenticate itself and encrypt all Baseband packets. The PIN that forms the basis of these security procedures is the same for connections between a Bluetooth device and a Service Relay as between a Bluetooth device and the originator. Since the Service Relay has to supply the PIN to get access to the service in the first place, this does not impose a security weakness.

FIG. 4 shows a tree network topology formed by method of the invention. The Service Relays 6 only connects to one device providing the relayed service either to the originator 4 or to one Service Relay 6, and it relays the service to zero or more devices 8 or in turn a Service Relay 6. Therefore the network has a simple tree structure, with one or more branches or leaves originating from each node. The originator of the service is master of the piconet 26, and the Service relays 6 are master of the respective Piconets 28, 30, 32, 34, 36, 38, 40. The tree structure of FIG. 4 is a strictly hierarchic structure, wherein every device has only one master device.

FIG. 5 shows a meshed network topology formed by method of the invention, by interconnecting branches of the tree topology of FIG. 4. In difference to FIG. 4 the Service Relay 6 connected to the Piconets 32, 34, 36 is connected to two Service Relays 6 as a slave device, relaying the device of the masters of the piconet 32 and 34 and relays these services to two slave devices 8. There are also three slave devices 8 being connected as slaves to two piconets. These “double slave” devices are connected to the piconets 32 and 38, 32 and 40, and 36 and 40 respectively. The Piconets 28, 30, 32, 34, 36, 38, 40 have the same master devices as in FIG. 4, and are extended by inter-piconet connections meshing the tree structure of FIG. 4. The meshed structure of FIG. 5 is a hierarchic structure, wherein every device can have more than one master device.

FIG. 6 depicts a ring topology formed by the method of the invention. The six devices 6 are all capable of inter piconet communication and are in turn master of each other. The master of the piconet 26 is slave to the piconet 36. The master of the piconet 36 is slave to the piconet 34. following the piconets 32, 30, 29 to in turn to the piconet 26. The number of piconets closing the circle is not limited. The piconets 26 to 36 may be combined with the tree and the meshed structures of the FIGS. 3 and 4. As in the case of the FIGS. 3 and 4, the devices 6 have at least one service relayed back to the originator.

The presented invention provides a means of automatic network formation for Bluetooth networks, wherein devices in multiple piconets can join the same service. The service can be e.g. a certain network. Bluetooth devices can search for a keyword/description of a networking service that is known to be provided. The keyword or the description of the service or network can be accessed using the Service Discovery Protocol, for searching for networking service (e.g. “Sander's meeting”, “meeting room XX network”, etc.). Such a keyword can then be used to query the SDP database of a piconet master the device connects to.

Another advantage of the presented invention is that the created network has a tree structure. Each device capable of inter-piconet communication joins the network as slave in one piconet, and becomes the master in another piconet. The root of the tree is the originator (host) of the service. The tree structure can evolve to meshed or even ring structures, if interconnections between the branches of the tree structure are established.

A third advantage is that the attributes of the networking service are also relayed to the piconet of the service relay. This means that the addressing structure remains the same, also for the new piconet, as well as the security requirements remain the same. The relayed service will require the same authentication and encryption as the original service. E.g. the service relay can use the same Bluetooth PIN for the piconet is relays the service to.

If the root device provides access to an external network (NAP role), the security mechanisms for accessing that network can be applied to each new connecting node. The name and attributes of the external network are also available to each new connecting node e.g. 10BaseT, 100BaseT, Token Ring, GSM, GPRS, etc. These attributes include the speed of the network.

The presented invention is targeted at relaying the NAP and GN service defined in the PAN profile. However, it can be applied to any multi-hop network where a connection is established based on service advertisement. The presented invention can be implemented in conjunction with other network formation methods, as well as path optimization algorithms for traffic engineering.

This application contains the description of implementations and embodiments of the present invention with the help of examples. It will be appreciated by a person skilled in the art that the present invention is not restricted to details of the embodiments presented above, and that the invention can also be implemented in another form without deviating from the scope of the appending claims. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. A method of forming a wireless network, by a first network device (6) and a second network device (4) in a wireless personal area network (PAN) environment, by the steps of:
connecting said first network device (6) with said second network device (4);
determining at least one service provided by said second network device (4), said determining step being carried out by said first network device (6); and being characterized by,
implementing said determined service in said first network device (6).

2. The method according to claim 1, wherein first network device (6) is searching for a desired service,
said determining at least one service provided by said second network device (4) is performed by checking if said second network device (4) provides said desired service; and
said implementing said determined service in said first network device (6) is performed if said second device (4) is found to provide said desired service.

3. The method according to claim 2, wherein said connecting step comprises the steps of:
searching said PAN environment for network devices by applying an inquiry procedure by said first network device (6);
selecting network devices recited in an information obtained during said inquiry procedure by said first network device (6); and
connecting said first network device (6) with said selected network devices, said selected network devices being designated as second network devices (4).

4. The method according to claim 1, further comprising the step of connecting said first network device (6) to at least one third network device (8).

5. The method according to claim 4, further comprising the step of relaying said service from said second network device (4) to said third network device (8), via said first network device (6).

6. The method according to claim 5, further comprising the step of forwarding data according to said relayed service from said second network device (4) to said third network device (8), via said first network device (6), and vice versa.

7. The method according to claim 1, wherein said wireless PAN environment is a Bluetooth environment.

8. The method according to claim 7, wherein said first network device (6) is connected to said second network device (4) via a first piconet (26), according to the Bluetooth standard.

9. The method according to claim 7, wherein said first network device (6) is connected to said third network device (8) via a second piconet (28), according to the Bluetooth standard.

10. The method according to claim 7, wherein the determination of provided services is executed by querying a Service Discovery Protocol (SDP) database of said second network device (4).

11. The method according to claim 7, wherein the implementation of said service in said first network device (6) is executed by storing said service in a SDP database of said first network device (6).

12. The method according to claim 7, wherein said first network device (6) is advertising said service to establish said first network device as a master of said second piconet.

13. The method according to claim 9, wherein said first network device (6) is forming said second piconet by connecting third network devices (8) in said PAN environment.

14. The method according to claim 7, further comprising the step of transferring connection related data from said first piconet to said second piconet, and vice versa.

15. A computer program product comprising program code means stored on a computer readable medium for performing each of the steps of the method of claim 1 when said program product is run on a network device.

16. A network device capable of inter piconet communication, comprising:
at least one transmitting and at least one receiving means,
operating means connected to said transmitting and receiving means, wherein said operating means is configured to connect the device with at least a first piconet and a second piconet simultaneously, and
determining means to determine a service provided by a connected second network device, and means to implement said service in said network device.

17. The network device according to claim 16, further comprising means to relay data traffic from said first piconet to said second piconet.

18. The network device according to claim 16, further comprising a service discovery protocol database.

19. A network, comprising network devices as claimed in claim 16.
